(19) United States
(12) Patent Application Publication
(10) Pub. No.: US 2023/0303934 A1
(43) Pub. Date: Sep. 28, 2023

(54) ELECTRICALLY HEATED STEAM CRACKING FURNACE FOR OLEFIN PRODUCTION

(71) Applicant: LUMMUS TECHNOLOGY LLC, Houston, TX (US)

(72) Inventors: Baozhong Zhao, Houston, TX (US); David Lee Guymon, Houston, TX (US); Richard John Jibb, Houston, TX (US); Xueping Li, Houston, TX (US); Kandasamy Sundaram, Houston, TX (US); Eduardo Hart Rhedey, Houston, TX (US); Stephen J. Stanley, Houston, TX (US)

(73) Assignee: LUMMUS TECHNOLOGY LLC, Houston, TX (US)

(21) Appl. No.: 18/170,448

(22) Filed: Feb. 16, 2023

Related U.S. Application Data
(60) Provisional application No. 63/269,752, filed on Mar. 22, 2022.

(51) Int. Cl. C10G 9/24; B01J 6/00

(52) U.S. Cl. CPC C10G 9/24; B01J 6/008

(57) ABSTRACT

An electrically heated furnace including one or more unit cells. Each unit cell includes a radiant heating section, one or more process coils disposed within the radiant heating section, and a quench unit for cooling a cracked product from the one or more process coils and producing a quenched reaction product. The furnace also includes one or more electrical heating elements disposed within the radiant heating section, the one or more electrical heating elements are arranged to provide radiant energy to the one or more process coils. Further, the electrically heated furnace includes a first area corresponding to a heating area of the one or more electrical heating elements, a second area corresponding to a wall area of the wall on which the one or more electrical heating elements are disposed, and a third area corresponding to a surface area of the one or more process coils.

### FIELD OF THE DISCLOSURE

Embodiments of the present disclosure generally relate to an electrically heated furnace to produce bulk chemicals such as ethylene, propylene and butadiene as well as aromatics and other products (product gas) from a hydrocarbon feedstock (feed gas) at large scale.

### BACKGROUND

Steam crackers are at the heart of petrochemical production facilities as they produce the bulk chemicals for downstream processes. However, the energy source for a steam cracker is typically derived from burning fossil fuels with energy inputs over 900 MW for a world scale petrochemical facility. Large scale production is achieved by including multiple (say 6-8) reaction “coils” in a single furnace enclosure and using fossil fuels as an energy source for the endothermic reaction to convert hydrocarbon feedstock to useful products such as olefins. The tubular reactor is a preferred configuration and there are multiple configurations known in the art. The preheated hydrocarbon feed enters the coil at 500-730° C. and is heated rapidly to 750-925° C. The tubular reactor (or cracking coils) are designed to optimize the temperature and pressure profiles along the radiant coils in order to maximize the yield of valuable products with more rapid temperature increase in the inlet section and low pressure drops in the outlet section of the cracking coils. However, the energy input required is very large. If this energy is supplied by burning fuel, then significant amounts of CO₂ are produced, which range from 0.3-1.6 tons per ton ethylene (t/t), depending on the feed to the steam cracker. In addition, due to the high temperature required for the pyrolysis NOx emissions are produced in the flue gas.

A typical fuel-fired furnace used for the thermal cracking of hydrocarbons is illustrated in FIG. 1. The furnace 100 includes a radiant section 10 having floor and/or wall burners 12, as well as a convection section 14. Disposed in the convection section 14 are heating coils for recovering convective heat from the flue gas, which may be used to pre-heat the hydrocarbon feed 16, produce steam 20 from a boiler feed (BF) 18, and may be used to superheat a steam feed (Steam) 22 to high pressure steam (HP Steam) 20. Once the feed is pre-heated in one or more convection section coils, it may be fed to a reaction coil disposed in the radiant section 10 of the heater, rapidly heated, resulting in the desired cracking of the hydrocarbons, producing cracked gas 22. To prevent over-cracking, a transfer line exchanger 24 may be provided to rapidly cool the radiant section effluent, providing a cooled cracked gas product stream 26. A steam drum 28 and other heat recuperation devices may also be used to facilitate the heating, cooling, or mixing of the hydrocarbon and steam feeds, as suited to the particular flow scheme.

Various publications related to furnaces for cracking of hydrocarbons may include the following. WO2020245016A1 discloses one or more heat consuming processes (>500° C.), at least one of which is electrically heated. Products of heat consuming process are passed to energy carrier network with a capacity 5 GWh. U.S. Pat. No. 5,321,191A describes a process for pyrolysis in an electric furnace with a monolith structure constructed from a ceramic. WO2021214256A1 and WO2021214257A1 relate to protection systems for electrical reactors in the event that a reaction tube is damaged and there is a release of combustible gases into the reactor enclosure. US20090022635A1 teaches that a furnace for thermally cracking hydrocarbons may be subdivided into a plurality of discrete sectors and the heat source may be concentrated in the discrete sector. U.S. Pat. No. 9,908,091B2 discloses a furnace for steam reforming which includes at least one burner and at least one voltage source connected to reactor tubes. A current is passed through the reactor tubes to heat the feedstock. US20210254774A1 discloses a steam reformer with a combustion chamber containing reactor tubes. A heating element is placed inside the reactor tubes. US20210051770A1 discloses an electrically heatable solids packed apparatus for endothermic reactions including dehydrogenation of propane (listed, but not described in detail). The packed bed is divided into an upper, middle and lower sections which are electrically isolated. Heating is by means of electrodes installed in an electrically conductive solid-state packing. US20210171344A1 discloses a steam reforming reactor with a macroscopic structure supporting a catalyst coating. A current is passed through the macroscopic structure to heat part of the catalyst to >500° C.

US20210113980 ('980) describes a reactor system comprising an electrically heated furnace with at least one electrical radiative heating element inside the furnace (heat is transferred to a reactor tube by radiation). FIG. 2 herein is a reproduction of '980 FIG. 1, which illustrates the heating mechanism as including radiant and convective heat, the radiant heat being directed from the hot face (T3) of the walls or insulation of the reactor as well as the heating element (T2), and the convective heat being provided by circulation of vapors within the reactor, each providing heat to the reactor tube (T1).

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In one aspect, embodiments disclosed herein relate to an electrically heated furnace. The furnace includes one or more unit cells. Each unit cell includes a radiant heating section, one or more process coils disposed within the radiant heating section, and a quench unit for cooling a cracked product from the one or more process coils and producing a quenched reaction product. The furnace also includes one or more electrical heating elements disposed within the radiant heating section, the one or more electrical heating elements are arranged to provide radiant energy to the one or more process coils. Further, the electrically heated furnace includes a first area corresponding to a heating area of the one or more electrical heating elements, a second area corresponding to a wall area of the wall on which the one or more electrical heating elements are disposed, and a third area corresponding to a surface area of the one or more process coils.

Other aspects and advantages of the claimed subject matter will be apparent from the following description and the appended claims

### BRIEF DESCRIPTION OF DRAWINGS

FIG. 1 (prior art) illustrates a prior art system used for production of ethylene and other bulk chemicals from hydrocarbon feeds with the energy being supplied by burning fuel gas (and/or liquid fuel).

FIG. 2 (prior art) is a furnace system as described in US20210113980 whereby a large amount of electrical energy is supplied to a reactor with multiple coils, and the electrical supply is divided into zones.

FIG. 3 is an illustration of electrical heating elements used in embodiments herein where an advantageous coil spacing is provided and the coils are grouped into unit cells/enclosures.

FIG. 4 is a heater system of multiple unit cells combined to form a single heater system according to embodiments herein.

FIGS. 5 and 5A are 3D arrangements of unit cells using a SiC heating element system according to embodiments herein.

FIGS. 6 and 6A are General Arrangement drawings of the furnace system according to embodiments herein.

FIGS. 7 and 7A is a schematic showing the layout of two unit cells with a common feed inlet according to embodiments herein. This figure illustrates the components that are included in the defined unit cell (power controller/transformer, enclosure heating elements and quench device).

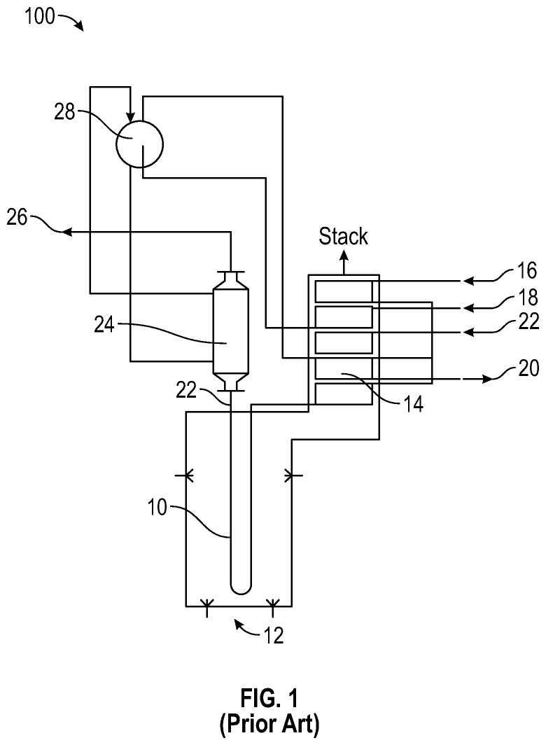

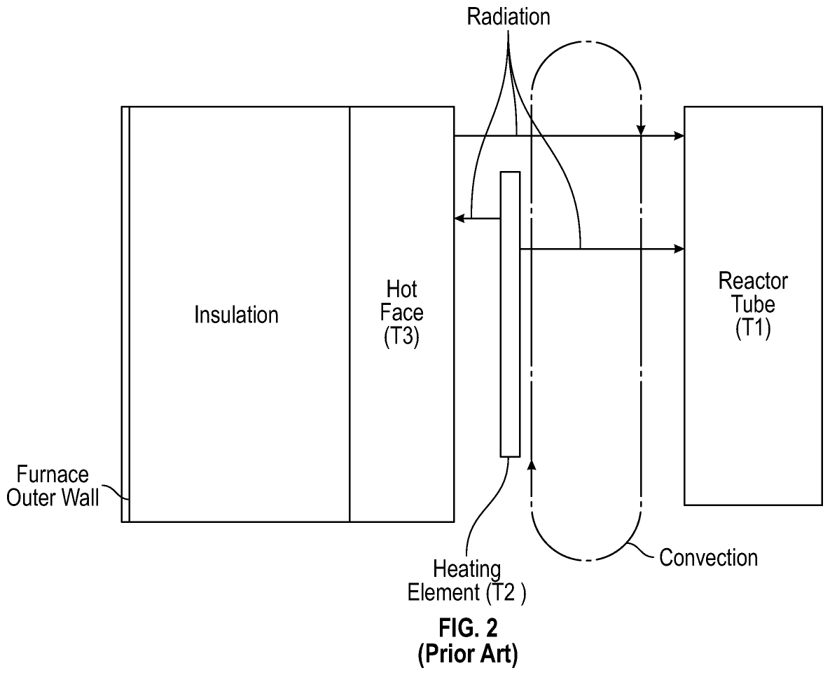

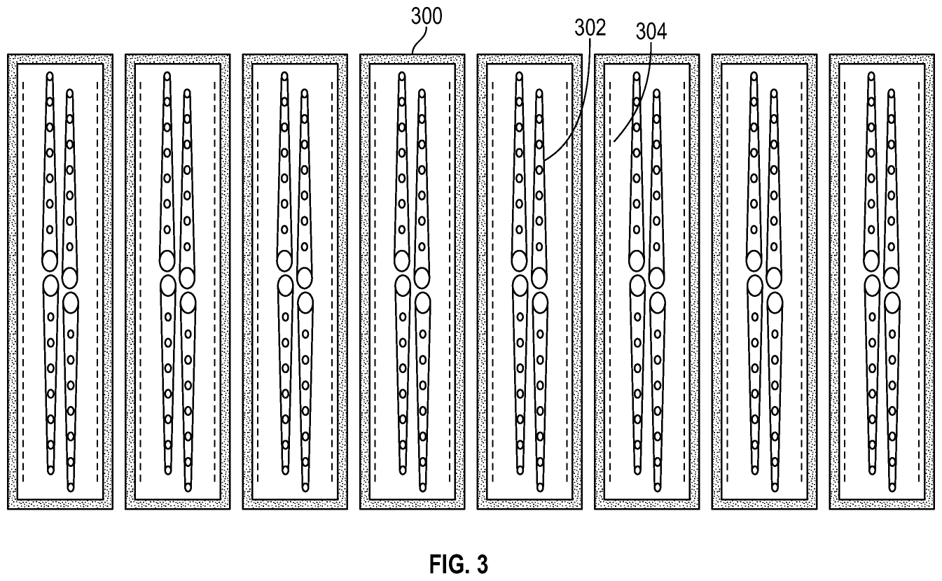

### DETAILED DESCRIPTION

One way to reduce or even eliminate emissions from large-scale production of olefins is electrification of the energy source, preferably where the electricity is supplied by renewable energy. Embodiments herein relate to electric furnaces for the production of petrochemicals, such as ethylene, propylene, and butadiene, as well as aromatics and other products for downstream processes. More specifically, embodiments herein are directed toward electrically heated furnaces to produce bulk chemicals such as ethylene, propylene and butadiene as well as aromatics and other products (product gas) from a hydrocarbon feedstock (feed gas) at large scale.

Rather than relying on burning of fossil fuels for the required energy input, embodiments herein provide a furnace that employs electrical resistance heating of multiple reaction coils in parallel. Each coil is housed in a separate unit cell enclosure with a heating area A1 corresponding to the heating area of the resistance elements installed on the walls of the unit cell enclosure, a wall area A2 corresponding to the area of the wall on which the elements are installed and a coil area A3 corresponding to the surface area of the reaction coils. The heating area A1 and the wall area A2 are greater than the reaction coil area A3.

The multiple unit cells are arranged along an axis and the reaction coils in each unit cell are configured perpendicular to this axis, or at a selected angle from 90 deg to 45 deg. By placing the unit cells in an arrangement at an angle, such as from 45 deg to 60 deg, the plot space of the overall reactor may be reduced.

There are a number of ways to supply the electrical energy to heat the coil and provide the necessary heat flux to the hydrocarbon feed for the thermal cracking process. These methods may include direct resistance heating by passing a current through the reactor coil, inducing a current by surrounding the coils with an electromagnet, or radiative heating from resistive heating elements adjacent to the coils.

Embodiments herein can apply any of these methods. Some embodiments include a method of heating which requires that resistance heating elements on the wall of an enclosure surrounding the reaction tubes since it can use the existing reaction coil designs with no modifications. Electrical heating elements have limits of heat flux at high temperature. The heating elements receive an electric current at an applied voltage, and heat is generated based on the element resistance. The element will increase in temperature until the electrical energy is dissipated as heat, or the material reaches its temperature limit and fails. Hence resistance beating elements will have a limit on applied heat flux at a given temperature. As the operating temperature increases, the maximum achievable heat flux decreases.

The heating elements are supported on a refractory wall and connected to an electrical supply. The resistance heating elements dissipate electrical energy by means of joule heating and by radiation. The electrical heating elements radiate energy towards the reaction coils and the furnace interior surfaces, such as towards the wall upon which the elements are supported. There are several types of heating elements that are suitable for the temperatures in the ethylene furnace, including NiCr, FeCrAl, SiC and MoSi₂ types. NiCr is the cheapest but also the most limited with a maximum temperature of 1100° C. FeCrAi is another metallic element type that can be used up to ˜1300° C. SiC elements can be applied up to 1600° C. or more, and MoSi₂ elements up to 1750° C. These values vary depending on the reference source but the values quoted are representative. Additionally, there is a requirement to consider aging of the elements and the appropriate operational margins. If the heating elements are operated close to their maximum permissible temperature the service life of the element may be reduced, and small increases due to changes in operation could result in element failures. Hence for the longest service life it is preferred to operate the element as far from its maximum permissible temperature as possible. In practice this means that the preferred approach is to provide a wall area that is greater than the surface area of the heat sink (reaction coils). In some embodiments, the heating element may be in a rod over bend (ROB) configuration or rigid Silicon Carbide rod type elements. For example, FeCrAl (metallic) elements may be provided in a rod over bend (ROB) configuration or rigid Silicon Carbide rod type elements. Rigid SiC elements are used in one or more embodiments as they are available in lengths of 1 m to 10 m, such as about 5 m. Such lengths are compatible with the dimension of the housing used to contain the individual reaction coils. Multiple rigid SiC elements can be arranged horizontally in a single span adjacent to, and supported on, the wall of the furnace enclosure (creating a unit cell). The electrical heating elements and reaction coils will require periodic maintenance or replacement. By placing the elements on the wall and separate from the reaction coils, access to the furnace for maintenance activities is achieved.

For a large heater installation (e.g., 8 or more unit cells), the individual unit cells may be configured such that in the event of a single coil rupturing, electrical supply to the affected unit cell is immediately stopped, while the electrical supply to the remaining unit cells can be stopped if required in a manner that does not cause disruption to the electrical supply utility.

The unit cells are arranged such that advantageous coil configurations can be used. Unlike US20090022635A1, where the furnace is divided into sectors, each radiant coil of embodiments herein is enclosed in a single unit cell with access for coil replacement and maintenance between each unit cell. Carbon deposits, or coke, typically form on the interior walls of the reaction coils. Coking deposits reduce the heat exchange efficiency causing an increased tube wall temperature and increased pressure drop. To maintain the tube metal temperature below its maximum permissible design temperature and to limit pressure rise in the coil affecting yields, or both, periodic decoking operation is required. Decoking typically is carried out at a lower temperature and reduced heat input than the pyrolysis reaction. Conventional furnaces containing multiple reaction coils and may require a spare heater (e.g., a plurality of extra coils) of capacity to allow for scheduling of the decoking operation. Decoking of the unit cells, according to one or more embodiments herein, is greatly simplified by the fact that each reaction coil is housed within a separate unit cell. Thus, the need for a spare heater is eliminated. Decoking with steam only, which takes longer but allows for the effluents to pass through the heat recovery section, is also facilitated by the unit cells ad disclosed herein.

In the case of radiant heating using electrical resistance heating elements, the unit cells may be grouped in sets to form a single heater system. This arrangement increases the available area of the enclosure side walls such that it is ideally 1.2-3.0 times greater than the heat sink area, which reduces the temperature of the element required to dissipate a given amount of heat. It is important to note that operating resistance heating elements “at the limit” for an extended period will reduce element life and will not provide adequate deign margin in case some of the elements fail. With improvements in element technology, available area to reactor (coil) surface area can be below 1.2 and it can be as low as 0.5. However, embodiments herein may be applied at a ratio above 1.0 for the reasons stated above, and the achievable area ratio will depend on the maximum heat flux of the heating elements, which may be different for metallic elements compared to ceramic SiC elements.

Each unit cell includes an air controller that operates in air, or with a controlled atmosphere with oxygen concentration low enough to avoid risk of explosion, but sufficient to maintain protective oxide layer on element surface.

For a world scale steam cracker, a large number of tubes are required to achieve the required capacity. Reaction tubes are grouped into “coils”. The coil configuration is carefully selected on the basis of cycle time (between decoking operations), residence time, pressure drop, and heat transfer to obtain the maximum product yields.

It is desirable to maintain the coil configurations which have been developed over many years and have a long proven operational record. Cracking heaters for ethylene production may dispose multiple radiant coils in an inline arrangement in a single row. In many cases, two rows are arranged either in offset arrangement or staggered arrangement. Even multiple rows of coils may be used as described in Lummus patent application PCT/US2021/59542, the coil arrangements of which are incorporated herein by reference. These multi-row arrangements are used in order to maximize the amount of ethylene product that can be obtained from a single heater system, before it is necessary to duplicate the system (i.e., build a second, third heater and so on). Typically, multiple coils are grouped together as a single “heater”. In this context, a group of multiple coils in a heater may be considered as an individual “heater system” with a single enclosure, and a unit of ethylene production capacity for the facility—typically in the region of 100-300 KTA ethylene production capacity per heater. Multiple individual heater systems may be required to achieve a desired capacity. In the prior art, heater systems employing electrical heating methods have been considered only as groupings of multiple coils in a single heater system. However, the heating methods proposed in the prior art have not been considered in the context of providing heat by electrical means to a large number of individual reaction tubes configured as radiant coils.

There are a large variety of different coil designs. Coil configurations may be referred to using a shorthand notation as an x-y arrangement, an x-y-z arrangement, a x-y-z-w arrangement, or others, where x refers to the number of inlet tubes and y refers to the number of tubes in the next pass, be it an outlet pass (x-y) or a second pass x-y-z, with z being the outlet pass. For example, if the arrangement is a 4-1, then four inlet tubes feed one outlet tube. A large number of coil design possibilities are discussed in PCT/US2021/59542. Coil configurations include simple x-arrangement, where x-tubes are connected in parallel to form a coil.

The heater system according to embodiments herein includes feed preheating, indirect quenching and high pressure steam generation and product cooling. Each unit cell has a dedicated quench device to minimize the residence time in the adiabatic section ahead of the quench cooler. The quenching system cools the cracked gas to a temperature low enough to freeze the reaction, but high enough to enable significant heat recovery, ideally in a range 550-680° C. This is important because, as previously mentioned, there is no flue gas in an electric heater and the electrical energy required should be prioritized for providing the heat of reaction. Using electrical energy to (effectively) generate steam, or to preheat feed at low temperature would require a larger electrical supply system. At certain times when economics (or for other reasons) dictates high level of steam generation, steam temperatures lower than 550° C. may be used, and as low as 300° C. in other embodiments. In these situations, feed preheating may be done by other means including a separate electric heater.

The unit cells are configured such that the longest dimension in the horizontal plane is parallel to the element plane in some embodiments. Along the longest dimension the tubes are placed in a single row or in multiple rows.

For a large heater installation (8 or more unit cells) the individual unit cells may be configured such that, in the event of a single coil rupture, electrical supply to the affected unit cell is immediately stopped, while the electrical supply to the remaining unit cells can be stopped in a manner that does not cause disruption to the electrical supply utility, and minimizes the amount of gas that needs to be vented to a flare system or other safety system.

A unit cell size of ˜3.0×5.0×15.0 m can be used in some embodiments, such that a single SiC element can be used across the longest dimension in the horizontal plane. As previously described, this facilitates maintenance and access to both the heating elements and the reaction coils. Elements may be connected in series (2) such that all electrical connections are on one side of the unit cell. Alternatively, groups of elements can be connected to a three phase electrical supply using a Delta or Wye configuration. Such configurations may be selected over the series arrangements, particularly in the case of SiC type elements, since variations in element resistance can lead to accelerated aging. Furnace temperature is in the range 1150-1250° C. with a heat flux (based on wall area) of about 50-120 kW/m2. This is well below the maximum capacity of commercially available SiC heating elements. In one or more embodiments, the area of the heating elements on the side wall is ˜1.0-1.6 times the surface area of the reaction coils. However, with high heat flux SiC or improved elements, the ratio can be less than 1.2, such as 0.8 to 1.2 or 1.0 to 1.2.

A unit cell size of ˜3.0×10.0×15.0 m can be used with metallic elements in other embodiments. In this configuration, the element heat flux is limited to around 30-40 kW/m2, or 33 kW/m2, which enables the use of metallic elements at a temperature of ˜1200° C. The area of the side walls is ˜3.0 times the surface area of the reaction coils.

In both of the above examples the heating duty is ˜10 MW, which is a convenient quantity with respect to the electrical supply. Two 5 MVA or one 10 MVA transformers may be used to supply each unit cell. This provides enormous flexibility in operation, enabling the following: (i) Each coil can be operated with a different feed and different severity; (ii) Individual coils can be operated on different decoke cycles; (iii) Power supplied to each unit cell may be varied based on a pre-determined coil outlet temperature; and (iv) Individual coils may have conventional steam/air decoking process with proper flow distribution control, alternatively individual coils can be operating in steam only decoking while other coils are operating in cracking mode.

FIG. 3 illustrates the arrangement of coils within each unit cell enclosure 300, and the arrangement of multiple unit cells 300 relative to each other. Each coil 302 grouping as shown consists of 28 inlet tubes and 4 outlet tubes connected via a common manifold. However, other coil designs are possible including configurations in which there are a collection of individual tubes consisting of an inlet section and an outlet section, split coils with small inlet coils headered into a larger outlet coil, or swaged U or W configurations. For illustration, a split coil arrangement is shown. However, any type of coil may be used, including many parallel tubes (known as single pass coil in the industry) and multi-pass serpentine coils (a single coil with many tubes in series).

Each coil grouping contained within the unit cell enclosure is heated by an electrical heating device 304, and in some embodiments use SiC or FeCrAl electrical resistance heating elements installed on the wall(s) of the unit cell enclosure. The unit cell enclosure can be insulated using known refractory insulation materials and the refractory insulation can be provided with hangers or similar to support the heating elements on the wall.

In order to illustrate the unit cell concept, two calculations are provided for the radiative heat transfer from heating elements installed on the wall (surface 1) to the reactor tube coil assembly (surface 2) using a simplified two surface resistance model.

Example 1: Considering metallic FeCrAl heating elements with a maximum heat flux of ˜33 kW/m² at a furnace temperature of 1200° C. and a tube metal temperature of 1080° C. with absorbed heat flux of 86 kW/m². The unit cell dimensions are 3 m×5 m×14 m so the area of the side walls is 2.8×10 m×14 m=280 m². In contrast, the tube area is 105 m² (ratio 2.7). If the desired heat duty for the reaction is 9.0 MW, and this can be supplied using a wall heat flux of 32.3 MW and an element temperature of 1175° C.

Example 2: Considering ceramic SiC heating elements with a heat flux of ˜70 kW/m² at furnace temperature of 1300° C. and a tube metal temperature of 1080° C. with absorbed heat flux of 86 kW/m². The unit cell dimensions are 2.8 m×5 m×14 m the area of the side walls is 140 m² compared to a tube area of 105 m² (ratio 1.3). For the same 9.0 MW heat duty as example 1 the wall temperature will be 1237° C.

Hence the dimensions of each unit cell may be selected on the basis of the required heat flux at the wall and the absorbed heat flux at the reactor coil.

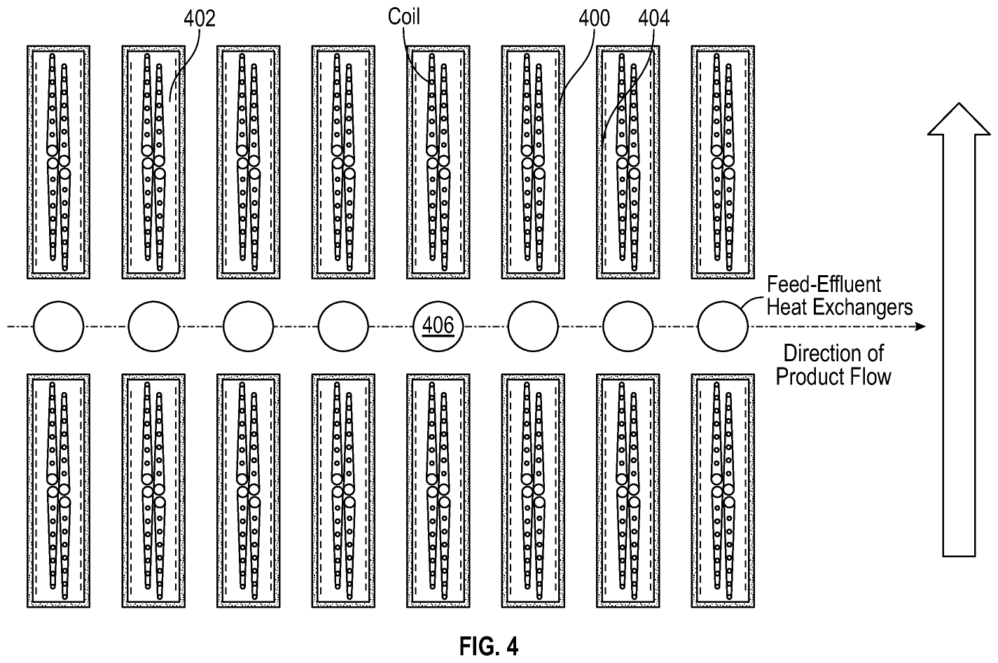

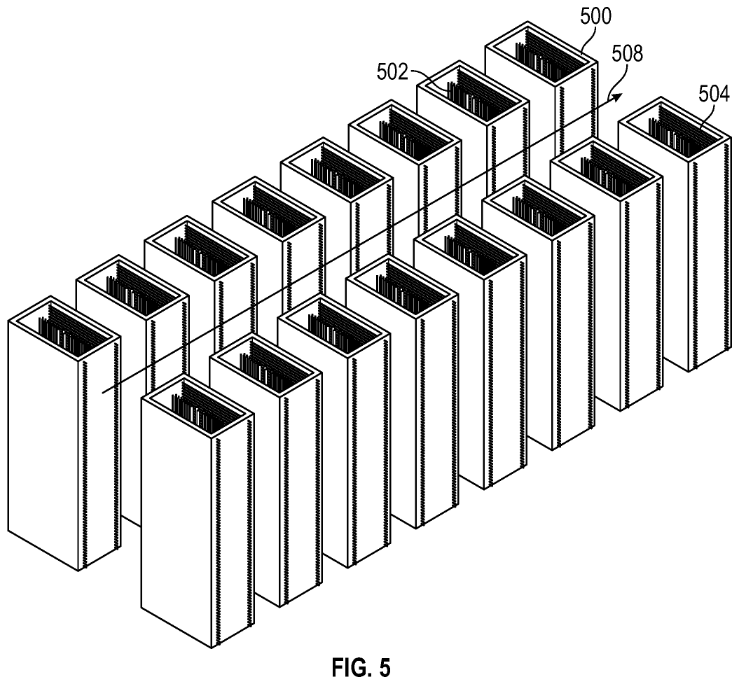

Referring to FIG. 4, multiple unit cells 400 are arranged such that the longest wall in the horizontal (x-y) plane is directly adjacent to the next unit cell and so on. The individual reaction tubes 402 are disposed in one or more rows with the inlet tubes 406 being placed either side of the outlet tubes which are grouped towards the center of the enclosure. Each of the multiple unit cells 400 is heated using electrical heating device 404. Each unit cell will have a quench unit (not shown in FIG. 4 for clarity) which receives cracked gas from the outlet tubes and rapidly cools it to a temperature below the reaction temperature, i.e., cooled from reaction temperature to a temperature of less than 700° C., such as in the range 550-680° C.

Cracked gas produced in the reaction coil of each unit cell 400 can be cooled and fed to a single transfer line dedicated to a group of unit cells, and thereafter fed to a main transfer line for the entire facility for downstream separation. A preferred method for further cooling the cracked gas from the quench unit is in a feed-effluent heat exchanger, often referred to as a secondary transfer line exchanger (STLE). There are many suitable configurations of STLE, and one STLE can cool cracked gas and heat feed for a single unit cell, or multiple unit cells. It is desirable to heat the feed to as high a temperature as possible so that the minimum amount of electrical power is required for the furnace heating. The feed may be heated above 550° C. and preferably above 600° C., even as high as 635° C. prior to being fed to the reaction coil.

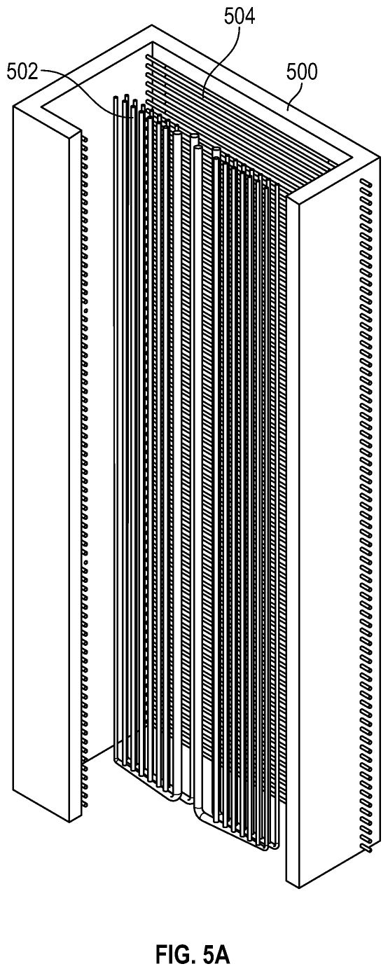

FIGS. 5 (multiple unit cells) and 5A (single unit cell) show unit cells 500 which use a silicon carbide heating element 504. The heating elements 504 are shown in horizontal arrangement, as an example. The heating elements 504 can also be in vertical arrangement, or in different geometries depending on the specific installation requirements. In FIG. 5, the rows of unit cells 500 are arranged along an axis 508. The hydrocarbons will flow along this line from the inlet side to the TLE side.

In consideration of the high current and physical scale of an electrically heated steam cracking furnace, it is advantageous to reduce the length of cables required for providing power to the heating elements. In some embodiments, an electrical circuit that enables routing of cables to one side of the unit cell would be selected. In the case of SiC elements that span across the full length of a unit cell, a circuit configuration using a Wye, or alternatively a Delta, arrangement may be used. The advantage of the Wye circuit is a simplified wiring scheme where on one side of the unit cell all heating element ends will terminate to a common neutral bus, while all the line voltage connections will be on the opposite side of the unit cell, limiting the cable runs to only one side of the unit cell. Similarly, a Delta circuit could be used, however, using two adjacent elements connected in series to avoid running line voltage cables to both sides of the unit cell. Multiple elements can be grouped in a circuit which is regulated using a voltage control unit. Silicon Controlled Rectifiers (SCR) are solid state switching devices which provide fast, infinitely variable proportional control of electric power to resistive loads, and are particularly well suited to the current application. A single SCR may be dedicated to 250 A to 2100 A of current, depending on the number of elements in each circuit. There will be multiple individually controlled heating circuits in each unit cell. For example, in a 10 MW unit cell, there can be 6 circuits controlling 1.66 MW of power to each circuit.

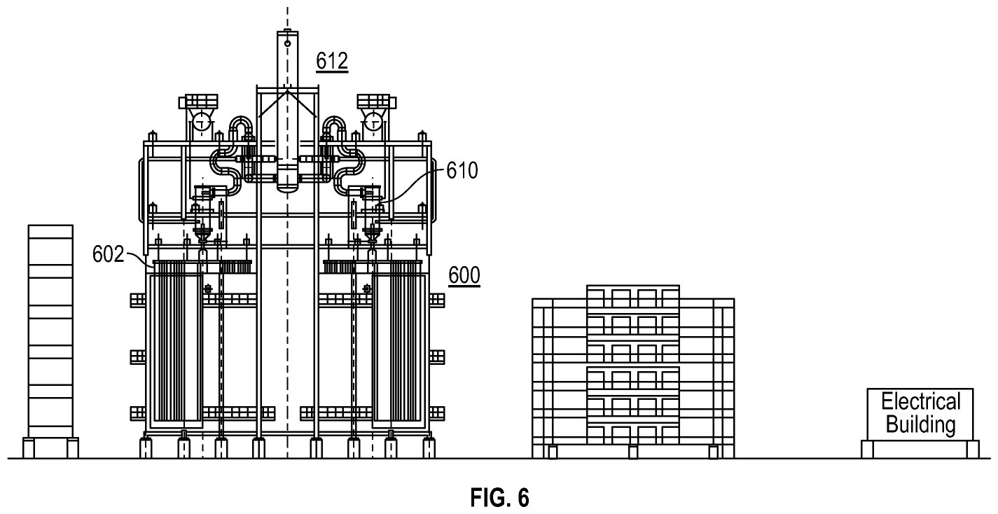

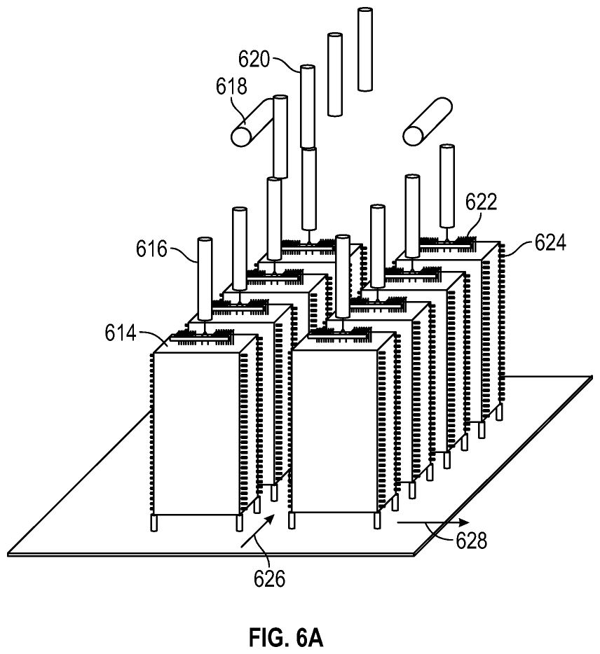

FIGS. 6 and 6A are General Arrangement drawings of a grouping of unit cells 600 arranged as a heater system, each unit cell 600 having reaction coils 602. As illustrated, in some embodiments, each unit cell 600 has a single dedicated quench unit 610, which in this case is fed by a steam drum. The effluent is further cooled in a STLE heat exchanger 612 against incoming feed, dilution steam mixture. The STLE 612 may heat feed and cool cracked gas from one two or more unit cells 600. Instead of hydrocarbon steam mixture, other fluids such as steam only can also be considered. However, in other embodiments, each unit cell can have an individual quench systems and feed preheat/effluent cooling heat exchangers may be shared between two or more unit cells, or there may be two or feed preheat/effluent cooling heat exchangers per unit cell.

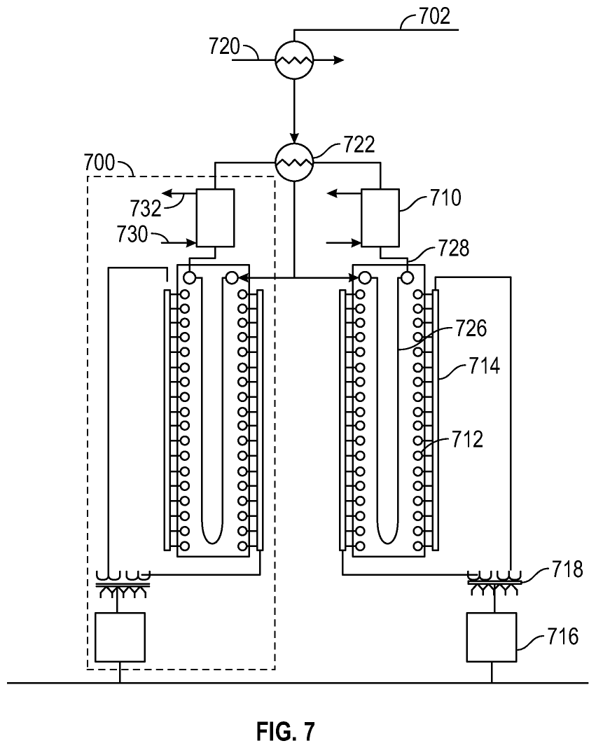

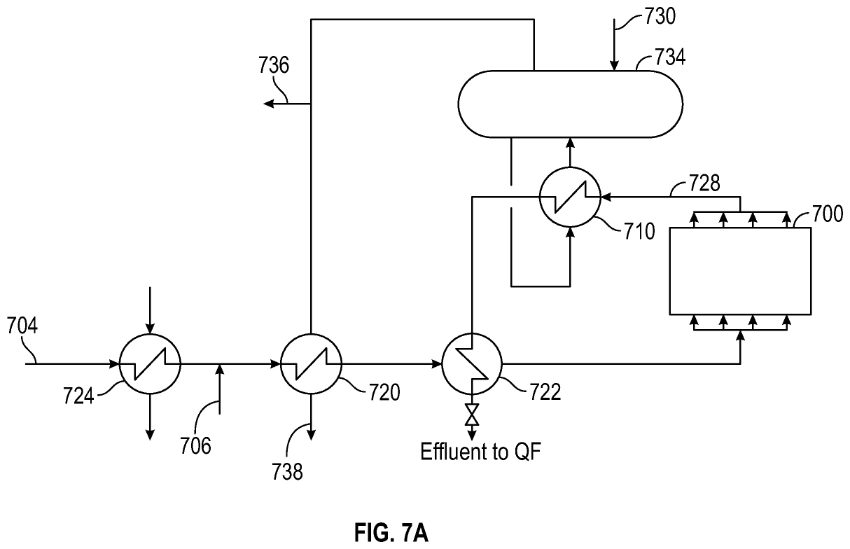

FIGS. 7 and 7A show one or more unit cells 700 which share a common feed 702 including hydrocarbon 704 and dilution steam 706.

Embodiments herein may include unit cells 700 that each include: (i) A single reactor coil consisting of a group of reaction tubes with a common feed; (ii) A quench device 710; (iii) An enclosure; (iv) Heating elements 712, connected to an electrical supply via bus bar 714 (or similar); (v) a Power controller 716; and (vi) a Transformer 718. Further, multiple unit cells will have a common high voltage electrical supply.

In embodiments illustrated in FIG. 7, feed 702 and dilution steam are preheated in a first preheat section 720 followed by further heating in a secondary TLE 722 against quenched cracked gas from the quench unit 710 from both unit cells. Two or more unit cells may share a common feed and a common feed preheat device. In the embodiment shown in FIGS. 7/7A, two unit cells share a common feed with associated preheat and secondary transfer line heat exchange, however the primary quench system is part of the unit cell system. The feed and dilution steam mixture is divided between the two unit cells and fed to reaction coils 726 consisting of a grouping of reaction tubes which are each individually housed in a unit cell 700 enclosure. The reactants are heated to a temperature of 750-925° C. and thermally cracked to produce a cracked gas 728 in each set of reactor coils. In embodiment illustrated in FIG. 7A, the feed 704 is heated in a naphtha heater 724 before being mixed with dilution steam 706 and fed to the first preheat section 720.

The radiant heating is provided by resistance heating elements 712 which are inside the unit cell 700 enclosure, and are preferably installed on two sidewalls of the enclosure. The elements are supplied with an electrical current from a main supply (Bus A 714) which is at high voltage, such as in the range 13 kV to 34.5 kV via a power controller 716 and a transformer 718 which steps down the higher supply voltage to the lower and the absorbed heat flux at the reactor coil.

Cracked gas 728 produced in the reaction coil 726 of each unit cell 700 can be cooled and fed to a single transfer line dedicated to a group of unit cells (quench unit 710), and thereafter fed to a main transfer line for the entire facility for downstream separation. Some embodiments provide for further cooling the cracked gas from the quench unit 701 in a feed-effluent heat exchanger 722, often referred to as a secondary transfer line exchanger (STLE).

In the radiant coil the hydrocarbon feed must first be heated to reaction temperature, prior to thermal cracking reaction. It is known to use multiple inlet tubes for each outlet tube, so that the fluid may be heated rapidly prior to cracking at high temperature in a short residence time (in a single or smaller number of larger diameter outlet tubes). This short residence time in the reaction section improves selectivity towards the desired products.

In the case of an electrically heated furnace there is no flue gas, so any heat recovery is primarily from the product cracked gas 728. It is desirable to maximize the temperature of the feed entering the inlet of the reaction coils 712, since this will minimize the amount of electrical energy required to reach the reaction temperature. Ideally the electrical energy should be prioritized for the endothermic heat of reaction required to produce the desired products.

It is also desirable to rapidly quench the reaction products which exit the radiant coil at ˜750-925° C. Ideally the cracked gas 728 should be cooled instantaneously, but in practice this means that the residence time in the adiabatic section between the furnace outlet and the quenching system should have a short residence time, ideally <10% of the residence time in the radiant coil. Direct and indirect quenching methods have been used, with indirect quenching generally being a preferred method permitting the generation of valuable high pressure steam. For the above reasons, it is usual for the quench cooler (also referred to as a primary transfer line exchanger) to be located as close as possible to the outlet of a reaction coil. Suitable heat exchanger types are Arvos Transfer line exchanger, Bath-tub type, Quick quencher type, or Borsig “Tunnelflow” or “Linear type” transfer line exchangers. Other super high pressure or medium to high pressure exchangers can also be used. Such systems may use boiler feed water 730 to cool the cracked product 728, producing steam 732. A steam drum 734 may be used to the collect the steam, and produce export stream 736 and condensate 738.

For embodiment furnaces herein, the reaction coils are not grouped into a “heater system” but instead are housed in individual unit cells. Hence the enclosure (furnace box) is broken into discrete sections with a dedicated electrical supply and control for each unit cell. In embodiments herein, each unit cell can be considered an individual control zone, entirely independent of the coils contained within each unit cell. The power supplied to each unit cell may be varied based on a measured coil outlet temperature.

The unit cell concept is particularly useful when the heating method is radiative employing electrical resistance elements. For metallic elements made from FeCrAl wire, the coil spacing, and side wall area can both be increased such that the elements may be installed on the wall, and operated at a temperature of 1100-1200° C. and heat flux 30-40 kW/m². In the prior art the elements would need to be installed on a single very long sidewall (perhaps in excess of 90 m long). Conceptually, a single long furnace is essentially broken into several smaller sections which are each then rotated by 90 degrees, such that the coil assembly longest dimension in a horizontal x-y plane (z being vertical height) is perpendicular to an axis.

SiC heating elements can be advantageously used in embodiments herein, as the box dimensions are suitable to allow, for instance: (i) Rigid elements that can be installed horizontally on a furnace wall to span the longest dimension in the horizontal plane. Such element installation may be removable, in operation—or in the case of significant maintenance activities the elements can be removed independently of the reaction coils (i.e., the elements do not have to be removed in order for the coils to be removed or vice versa). In the prior art, the single heater system enclosure would be too long to allow a single element to span the longest dimension of the enclosure; and (ii) Multiple elements installed horizontally from top to bottom, possibly in separate zones.

In summary desirable electric heater system would have the following features: (i) Maintain the best design practice with respect to coil layout and residence time, and provide for flexibility in the coil layout; (ii) Allow for the use of available heating elements that have been proven and are in widespread use at the temperatures required for the ethylene cracking furnace; (iii) Have a surface area for heating elements that is greater than the surface area to be heated (maximizing element life); (iv) Provide for safe operation by allowing a single unit cell to be isolated and shut down quickly in the event of a coil rupture, without affecting the balance of the reactant system; (v) Provide the maximum possible feed inlet (crossover) temperature at the inlet to the radiant section, to minimize the amount of electrical energy that needs to be dissipated by the elements as this is the highest value heating source; and (vi) Facilitate rapid quenching of the reaction products to maximize the yield of valuable products

As described above, embodiments herein provide a suitable electric furnace system for a large scale thermal cracking process. Embodiments herein may maintain the optimal coil layout that has been developed for fuel fired furnaces, hence increased coking rate should not be a concern. In fact, as the electrical heat may be more uniform than fired heating coking limitations due to hotspots, coking may actually be somewhat lower with an electrically heated system.

Embodiments herein further provide a furnace configured as a series of unit cells, each containing a reactor coil with corresponding manifolds, and each coil manifold is aligned perpendicular to an axis. The heating elements can be attached to the refractory wall rather than along the reactor tube, or in the form of coaxial radiative sheeting, and the area of the heating elements A1 as well as the refractory area associated with heating elements (A2) is greater than the area of the coils to be heated (A3). The available heating element types are limited to a certain heat flux which decreases as the operating temperature increases and operating life of the heating elements will also depend on temperature at which the element is operated. For instance, an FeCrAl type element is limited to a heat flux of ˜30-40 kW/m² if operated at a furnace temperature of 1200° C. If the absorbed heat flux required for the endothermic reaction is >40 kW/m², then the surface area for the heating elements needs to be higher in order to satisfy the constraints of heat flux, temperature at the required heat duty. The unit cell arrangement increases the ratio of refractory area to reactor coil area relative to the prior art practice of including multiple reaction coils in a single structure. Embodiments herein thus allow for the tube spacing to be increased within each unit cell.

Embodiments herein are also concerned with the arrangement of reactor coils within individual unit cells, the arrangement providing advantages in terms of higher wall area per unit coil area, and isolation of unit cells with respect to electrical supply and in the event of a coil rupture. It should be noted that embodiments herein allow for different heating methods to be used, or a combination of methods. For instance, some of the required heat may be supplied by non-radiative heat transfer, such as by passing a current directly through the reactor coil. This can be a direct current or an alternating current, recognizing that the electrical resistance of the reactor tube is relatively low, requiring a large current flow if the full heating duty is to be provided by this method. An alternative is to provide some of the heating duty by non-radiative heating.

Optionally, an inert and gas with reduced oxygen content (<10%) is fed into the reactor enclosure to ensure that an explosion or combustion event is limited in the event of a hydrocarbon release. While such precautions are also anticipated, the added advantage of a unit cell enclosure is that in such event the quantity of gas that would have to be released from the enclosure is significantly reduced and the event may be contained. In embodiments, the power supply to the affected unit cell can be immediately stopped, whilst the power supply to the remaining unit cells can be reduced more gradually if required.

For electrical heating according to embodiments herein, a quantity of power is in the range 5-10 MVA for supplied power. A single coil assembly would have a similar required heat input, in the range 8-10 MW absorbed power. Hence, furnace heat input may be controlled by splitting the enclosure into unit cells such that each unit cell is supplied by a single transformer or pair of transformers.

Resistance element voltages are low (200-600V) compared to grid supply voltages (30-40 kV). In the industry 200-600V is considered as low voltage. For illustration low voltage is used. When medium voltage elements (1000-6000 v) are available, they can also be used. The cost and number of control devices is greatly influenced by the electric current and can be much higher when the voltages are in the range 300-600V. Embodiments herein allow for each individual unit cell to be supplied by a small number, or even a single step down transformer. On the low voltage side of the step down transformers SCRs (Silicon Controlled Rectifier) control the voltage supply to the circuits of SiC resistive elements. A PLC will monitor the voltage and current in the circuits and calculate the power flowing through the elements in real time. The PLC will then be able to adjust the voltage supply through the SCR to achieve a given power demand set point. To avoid an overtemperature event in the heating elements the PLC will also monitor the temperature of the element and reduce or limit the power set point or ultimately trip the circuit. Optionally, a temperature set point can be used by the PLC and voltage varied by the SCRs to achieve a target furnace temperature.

The present inventors also recognized that to account for the difference between absorbed heat flux (say 90 kW/m2) and maximum heat flux of the elements (33 kW/m2 for metallic elements and 70 kW/m2 for SiC for instance), a much larger wall area was required such that coil spacing would need to be very large.

A controlled atmosphere would be required to account for possibility of a coil rupture. By isolating each coil in a unit cell, a safer approach is to isolate the individual unit cell from the rest of the system.

For instance if an induction coil is placed around each reaction tube then there will be insulation between the induction coil and the reactor tube, rather than on the wall of the enclosure there will be an electrical connection to the induction coil around each individual reaction tube. A high frequency alternating current is required. The enclosure will be relatively cool, but is still required to contain an inert atmosphere that limits combustion in the case of a coil rupture.

If a current is passed through each reaction coil, again there will need to be multiple electrical connections entering the enclosure. There are a number of configurations of electrical supply that can be used with the invention.

Each unit cell may be isolated from the others for a variety of reasons. In the event of a hydrocarbon release due to a leak or rupture, but also to allow for adjustments or maintenance without the need to bring down a large increment of overall plant capacity.

The unit cells may also provide for a decoking schedule. Each unit cell may be set up such that there are more individual decoke cycles run (up to a limit of one per unit cell) but the reduction in capacity for each decoke operation is less. One unit cell can be in decoke mode whilst other unit cells of a single heater are cracking hydrocarbons. This can be achieved by steam only decoking and all effluents pass through the recovery section. When a heater (all unit cells or coils or pre-selected unit cells/coils) are decoking, the effluent may be vented to the atmosphere via a decoke drum.

Unless defined otherwise, all technical and scientific terms used have the same meaning as commonly understood by one of ordinary skill in the art to which these systems, apparatuses, methods, processes and compositions belong.

The singular forms “a,” “an,” and “the” include plural referents, unless the context clearly dictates otherwise.

As used here and in the appended claims, the words “comprise,” “has,” and “include” and all grammatical variations thereof are each intended to have an open, non-limiting meaning that does not exclude additional elements or steps.

“Optionally” means that the subsequently described event or circumstances may or may not occur. The description includes instances where the event or circumstance occurs and instances where it does not occur.

When the word “approximately” or “about” are used, this term may mean that there can be a variance in value of up to ±10%, of up to 5%, of up to 2%, of up to 1%, of up to 0.5%, of up to 0.1%, or up to 0.01%.

Ranges may be expressed as from about one particular value to about another particular value, inclusive. When such a range is expressed, it is to be understood that another embodiment is from the one particular value to the other particular value, along with all particular values and combinations thereof within the range.

While the disclosure includes a limited number of embodiments, those skilled in the art, having benefit of this disclosure, will appreciate that other embodiments may be devised which do not depart from the scope of the present disclosure. Accordingly, the scope should be limited only by the attached claims.

What is claimed as new and desired to be protected by Letters Patent is:

1. An electrically heated furnace comprising:
one or more unit cells, each unit cell comprising:
a radiant heating section, one or more process coils disposed within the radiant heating section, and a quench unit for cooling a cracked product from the one or more process coils and producing a quenched reaction product;
one or more electrical heating elements disposed within the radiant heating section, the one or more electrical heating elements arranged to provide radiant energy to the one or more process coils,
wherein the electrically heated furnace includes a first area corresponding to a heating area of the one or more electrical heating elements, a second area corresponding to a wall area of the wall on which the one or more electrical heating elements are disposed, and a third area corresponding to a surface area of the one or more process coils.

2. The apparatus of claim 1, further comprising a feed inlet heat exchanger for preheating a reaction feedstock comprising one or more hydrocarbons and diluent steam, producing a preheated reaction feedstock.

3. The apparatus of claim 2, further comprising a transfer line heat exchanger configured for indirectly exchanging heat between the quenched reaction product and the preheated reaction feedstock.

4. The apparatus of claim 1, wherein the one or more electrical heating elements have a first end connected to a power source and a second end connected to a common ground, wherein the one or more electrical heating elements are arranged horizontally along one or more walls of the radiant heating section with each of the first ends arranged on a first side of the one or more walls and each of the second ends being arranged on a second side of the one or more walls.

5. The apparatus of claim 1, wherein the one or more electrical heating elements having a first end connected to a power source and a second end connected to a common ground, wherein the one or more electrical heating elements are arranged horizontally along one or more walls of the radiant heating section with the second end of a first electrical heating element being electrically connected to a first end of a second electrical heating element.

6. The apparatus of claim 1, further comprising a power controller configured for receiving electrical power from a power grid.

7. The apparatus of claim 6, further comprising a transformer configured for adjusting a voltage from the power controller to an operating voltage of the one or more electric heating elements.

8. The apparatus of claim 1, where in the one or more electrical heating elements are made of a material selected from the group consisting of NiCr, FeCrAl, SiC and MoSi₂.

9. The apparatus of claim 8, wherein the one or more electrical heating elements are made of SiC and have a length of between 1 m and 10 m.

10. The apparatus of claim 1, further comprising an oxygen controller configured for maintaining an oxygen concentration in the radiant section that is low enough to prevent an explosion and high enough to maintain a protective oxide layer on a surface of the one or more electrical heating elements.

11. The apparatus of claim 1, wherein the first area and the second area are each greater than the third area.

12. The apparatus of claim 1, wherein the one or more electrical heating elements are arranged in the radiant section at an angle of 45 deg to 90 deg with respect to the one or more process coils.

13. The apparatus of claim 1, wherein the one or more process coils are fluidly connected to a common feedstock header.

14. The apparatus of claim 1, wherein a plurality of the one or more unit cells are fluidly connected to a common quench unit.

15. The apparatus of claim 1, wherein a first of the one or more unit cells can be operated in a decoking mode or maintenance mode while a second of the one or more unit cells can be operated in a cracking mode.

16. An apparatus for cracking hydrocarbons comprising the electrically heated furnace of claim 1.
